(19) United States
(12) Patent Application Publication
(10) Pub. No.: US 2007/0193675 A1
(43) Pub. Date: Aug. 23, 2007

(54) Process of manufacturing a multilayer device and device manufactured thereby

(76) Inventors: Abhijit Gurav, Greenville, SC (US); Azizuddin Tajuddin, Laurens, SC (US); Daniel Skamser, Simpsonville, SC (US); Gary Renner, Easley, SC (US); March Maguire, Clemson, SC (US); Michael S. Randall, Simpsonville, SC (US); Randal Vaughan, Fountain Inn, SC (US)

Correspondence Address: NEXSEN PRUET, LLC, P.O. BOX 10648, GREENVILLE, SC, 29603, US

(21) Appl. No.: 11/359,074

(22) Filed: Feb. 22, 2006

(51) Int. Cl. C03B 29/00; H01G 4/06

(52) U.S. Cl. 156/89.12; 156/89.16; 361/321.3

(57) ABSTRACT

A process for forming a multilayer ceramic capacitor. The process includes depositing a ceramic precursor on a substrate and an electrode ink in a predetermined pattern on the ceramic precursor to form a green sheet. The electrode ink has an adhesion promoter incorporated therein. The green sheet is overlayed with at least one second green sheet to form a layered green sheet which is then fused under pressure.

### BACKGROUND OF THE INVENTION

The present invention is related to an improved method for forming a multilayer device and a device formed thereby. More particularly, the present invention is related to the formation of a multilayer device wherein adhesion promoters are incorporated into either the electrode deposit or the ceramic deposit in the margins to improve adhesion to subsequent layers thereby significantly decreasing the pressure required for fusing the layers.

Manufacturing of multilayer devices by lamination is a standard practice particularly in the manufacture of multi-layer ceramic capacitors (MLCC). As with any electronic component the ongoing desire for miniaturization and higher capacitance performance places continued burdens on every aspect of product properties and product manufacture thereby forcing those of skill in the art to continue to advance the art. It is highly desirable to increase the layer count while concurrently decreasing the layer thickness.

As layer counts in a multilayer device increase and as the dielectric and electrode thicknesses decrease manufacturing difficulties increase. In particular, it becomes increasingly more difficult to manufacture a device with minimal layer distortion, or non-planarity. Layer distortion is detrimental to the physical properties of the capacitor and is now realized to represent a significant cause of inferiority in capacitors. Past efforts to minimize physical distortion have involved optimization of the lamination time, temperature and pressure. The ability to mitigate the distortion by optimization is now confronted with diminishing success thereby requiring a novel solution to the problem.

The standard method for optimization of the lamination is to transfer a printed dielectric tape to a vacuum chuck followed by lightly laminating the printed tape to the pad to achieve alignment and transfer. After alignment and complete stack buildup, the pad is subjected to further lamination at relatively high pressure and temperature for a time sufficient to cause bonding of the layers and densification of the pad. The high pressure of lamination causes the undesirable distortion yet this has been considered necessary to achieve adequate bonding between layers.

There has been an ongoing desire in the art for a method of forming multilayer ceramic products with minimal distortion of the internal layers. The present invention achieves these goals.

### SUMMARY OF THE INVENTION

It is an object of the invention to provide a method for manufacturing multilayer ceramic components with minimal distortion of the individual layers.

It is another object of the invention to provide a method for manufacturing multilayer ceramic components at lower lamination pressures.

It is yet another object of the invention to provide a method for manufacturing multilayer ceramic components which increases manufacturing productivity and quality by eliminating the necessity for very high lamination pressures. It is another object of the invention to mitigate product deficiencies created by use of high lamination pressures.

A particular advantage of the present invention is the ability to realize the aforementioned objects without significant modification of equipment and processes thereby greatly enhancing the manufacturing capability with existing equipment.

These and other advantages, as will be realized, are provided in a process for forming a multilayer ceramic capacitor. The process includes depositing a ceramic precursor on a substrate and an electrode ink in a predetermined pattern on the ceramic precursor to form a green sheet. The electrode ink has an adhesion promoter incorporated therein. The green sheet is overlayed with at least one second green sheet to form a layered green sheet which is then fused under pressure.

Yet another advantage is provided in a process for forming a multilayer ceramic capacitor. The process includes depositing a ceramic precursor on a substrate. A second ceramic precursor is deposited in a predetermined pattern on the ceramic precursor wherein the second ceramic comprises an adhesion promoter. An electrode ink is deposited in a second predetermined pattern on the ceramic precursor to form a green sheet. At least one second green sheet is overlayed on the green sheet to form a layered green sheet which is fused under pressure.

A particularly preferred embodiment is provided in a process for forming a multilayer ceramic capacitor. The process includes depositing a ceramic precursor on a substrate followed by depositing an electrode ink in a predetermined pattern on the ceramic precursor. The electrode ink comprises an adhesion promoter. A second ceramic precursor is deposited in a second predetermined pattern on the ceramic precursor to form a green sheet wherein the second ceramic precursor has a second adhesion promoter. The green sheet is overlayed with at least one second green sheet to form a layered green sheet which is fused under a pressure of no more than 5000 psi (352 Kg/cm).

### BRIEF DESCRIPTION OF FIGURES

FIG. 1 illustrates a capacitor in partial cut-away view.

FIG. 2 illustrates a preferred process of the present invention.

FIG. 3 illustrates another preferred process of the present invention.

### DETAILED DESCRIPTION

The invention will be described with reference to the various drawings forming an integral part of the specification. In the various drawings similar elements will be numbered accordingly.

An improved method for manufacturing a multilayer ceramic device is provided herein. The method includes incorporation of an adhesion promoter to at least one applied layer of the printed tape. The adhesion promoter facilitates adhesion to the pad at low lamination pressure.

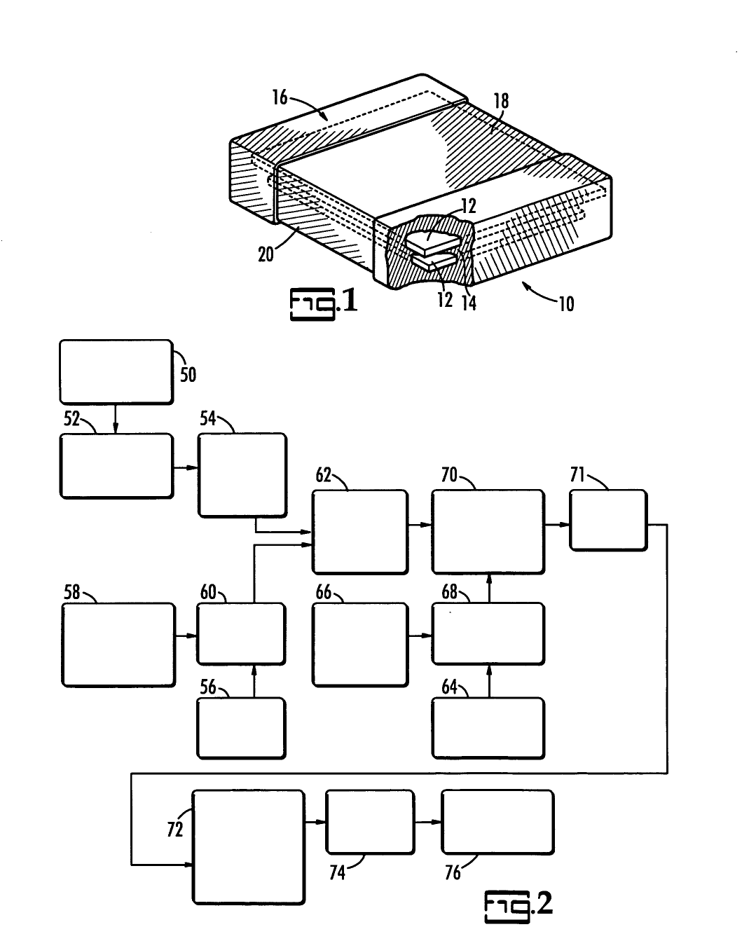

A multilayer ceramic device is illustrated in FIG. 1. In FIG. 1, the device, generally represented at 10, comprises internal electrodes, 12, with dielectric, 14, there between. As would be realized the plates are alternately in contact with external electrodes, 16, of opposite polarity. External electrodes are also referred to as terminations. A ceramic dielectric, 18, acts as a protective barrier. An internal layer, 20, facilitates electrical connectivity between the internal electrode and the external electrodes.

The internal electrodes are a conductive metal and are not particularly limited herein. The ceramic material is not particularly limiting herein, however, ceramics prepared by low-temperature sintering precursors or precursors which can be sintered in a non-oxidizing atmosphere are preferred. The internal layer is preferably a plated nickel layer and the external electrode is preferably a copper or silver layer with a tin finish to facilitate soldering.

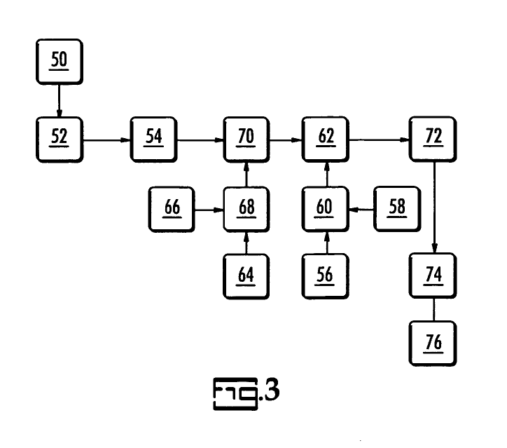

The process for manufacturing a multilayer ceramic capacitor will be described with reference to FIG. 2.

In FIG. 2, a ceramic powder is prepared at 50. The ceramic powder comprises ceramic precursors, organic vehicles, coating aids, and other ingredients typically utilized in ceramic capacitor formation. The ceramic powder is thoroughly mixed as known in the art to form a ceramic coating material at 52. The ceramic coating material is then applied to a substrate to form a ceramic dielectric tape at 54. In a parallel process the metal powders are prepared at 56. The metal powders are not particularly limited herein. In a preferred embodiment adhesion promoting additives are prepared at 58 and the adhesion promoting additives and metal powders are mixed at 60 to form an electrode ink. The electrode ink is then deposited on the ceramic dielectric tape at 62 in a predetermined pattern thereby forming a printed tape. It is often desirable to apply ceramic in the margins between the electrode ink deposits thereby further decreasing distortion during lamination. A ceramic margin powder is prepared at 64. The ceramic powder may be the same as the dielectric material used to form the ceramic dielectric tape at 54 or it may be different. It is most preferred that the ceramic margin powder have the same ceramic precursors, or ceramic components, as that in the capacitive element to insure that the thermal expansion parameters and densification/sintering properties are compatible. In a preferred embodiment adhesion promoting additives are prepared at 66. The ceramic powders are mixed, optionally with the adhesion promoting additives at 68, to form a margin ink. The margin ink is then applied to the dielectric between the electrode materials at 70 to form the printed tape, 71.

A series of printed tapes, or segments of printed tape, are layered at 72, and laminated with a low-pressure lamination to form a green chip. The ability to form the green chip in a low pressure lamination step represents an advantage over the art and is a preferred embodiment of the present invention. The prior art typically requires pressures in the range of 7000 pounds per square inch (psi) (492 Kg/cm) or greater to achieve adequate adhesion between layers. With the incorporation of adhesion promoters in the electrode and/or dielectric margin the pressure required to achieve adequate adhesion between layers is decreased to less than 5000 psi (352 Kg/cm) and more preferably less than 1000 psi (70 Kg/cm). In practice adequate layer adhesion can be achieved with a pressure under 600 psi (42 Kg/cm) and can be achieved at about 400 psi (28 Kg/cm). The ability to laminate at lower pressure greatly improves the quality of the finished capacitor. One advantage is a substantial decrease in the layer distortion typically resulting from compression. By reducing the layer distortion a substantial cause of failure and inferior capacitors is mitigated.

The green chip is subjected to a thermal process at 74 wherein the ceramic precursors are sintered and volatiles are removed as well known in the art to form a fired capacitor precursor. The fired capacitor precursor is then diced and termination is applied at 76 to form the finished capacitor.

The margins may be coated prior to formation of the electrode. This embodiment, illustrated in FIG. 3, is similar to the embodiment of FIG. 2 except that the margins are applied prior to the formation of the electrode. In FIG. 3 the ceramic powder is prepared at 50. The ceramic precursor is thoroughly mixed as known in the art to form a ceramic coating material at 52. The ceramic coating material is then applied to a substrate to form a ceramic dielectric tape at 54. The ceramic margin powder is prepared at 64. In a preferred embodiment adhesion promoting additives are prepared at 66. The ceramic powders are mixed, optionally with the adhesion promoting additives at 68, to form a margin ink. The margin ink is then applied to the dielectric at 70 to form the printed tape.

The metal powders are prepared at 56. In a preferred embodiment adhesion promoting additives are prepared at 58 and the adhesion promoting additives and metal powders are mixed at 60 to form an electrode ink. The electrode ink is then applied to the ceramic dielectric tape at 62 within the areas defined by the ceramic margin thereby forming a printed tape.

The series of printed tapes, or segments of printed tape, are layered at 72, and laminated with a low-pressure lamination to form a green chip. The green chip is subjected to a thermal process at 74 to form the final capacitor precursor. The fired capacitor precursor is then diced and termination is applied at 76 to form the finished capacitor.

The adhesion promoters are selected from those materials which are compatible with the coating and are preferably selected from pressure sensitive, hot melt, thermally activated, UV activated and e-beam activated materials. Non-limiting examples include isoprenes such as Escorez 5300, 5320, 5340, 5380 or 2520, available from Exxon Mobile; hydroabietyl alcohol such as Abitol E available from Eastman; butadienes particularly polybutadienes; acrylates particularly polyacrylates; isocyanates; cyanoacrylates; urethanes and polyurethanes; epoxies; natural wood derived tackifiers (rosin and polyterpenes) with a natural rubber base; waxes (natural and synthetic); styrene-butadiene rubber and styrenated block copolymers; hydrocarbon-modified rosen esters such as Resinall 500 series; aromatic and aliphatic hydrocarbon resins such as Resinall 700 series; phenolic modified rosin esters such as Resinall 900 series; modified rosins such as Resinall 200 series; rosin esters such as Resinall 600 series; gum adhesives such as guar gum or the like.

The multilayer ceramic chip capacitor of the present invention is generally fabricated by forming a green chip by conventional printing and sheeting methods using pastes, firing the chip, and printing or transferring external electrodes thereto followed by baking.

Paste, or ink, for forming the dielectric layers can be obtained by mixing a raw dielectric material with an organic vehicle. The raw dielectric material may be a mixture of oxides and composite oxides as previously mentioned. Also useful are various compounds which convert to such oxides and composite oxides upon firing. These include, for example, carbonates, oxalates, nitrates, hydroxides, and organometallic compounds. The dielectric material is obtained by selecting appropriate species from these oxides and compounds and mixing them. The proportion of such compounds in the raw dielectric material is determined such that after firing, the specific dielectric layer composition may be met. The raw dielectric material is generally used in powder form having a mean particle size of about 0.1 to about 3 μm, preferably about 1 μm.

The organic vehicle is a binder in an organic solvent. The binder used herein is not critical and may be suitably selected from conventional binders such as ethyl cellulose. Also the organic solvent used herein is not critical and may be suitably selected from conventional organic solvents such as terpineol, butylcarbinol, acetone, and toluene in accordance with a particular application method such as a printing or sheeting method.

Paste, or ink, for forming internal electrode layers is obtained by mixing an electro-conductive material with an organic vehicle. The conductive material used herein includes conductors such as conductive metals and alloys as mentioned above and various compounds which convert into such conductors upon firing, for example, oxides, organometallic compounds and resinates. The organic vehicle is as mentioned above.

Paste for forming external electrodes is prepared by the same method as the internal electrodes layer-forming paste.

No particular limit is imposed on the organic vehicle content of the respective pastes mentioned above. Often the paste contains about 1 to 5 wt % of the binder and about 10 to 50 wt % of the organic solvent. If desired, the respective pastes may contain any other additives such as dispersants, plasticizers, dielectric compounds, and insulating compounds. The total content of these additives is preferably up to about 10 wt %.

The dielectric layers may have any desired mean grain size with a mean grain size of about 0.2 to 0.7 μm being acceptable.

The dielectric layers have an appropriate Curie temperature which is determined in accordance with the applicable standards by suitably selecting a particular composition of dielectric material. Typically the Curie temperature is higher than 45° C., especially about 65° C. to 125° C.

Each dielectric layer preferably has a thickness of up to about 50 μm, more preferably up to about 20 μm. The lower limit of thickness is about 0.5 μm, preferably about 2 μm. The present invention is effectively applicable to multilayer ceramic chip capacitors having such thin dielectric layers for minimizing a change of their capacitance with time. The number of dielectric layers stacked is generally from 2 to about 300, preferably from 2 to about 200.

A particularly preferred ceramic comprises barium titanate, barium strontium titanate or barium strontium zirconium titanate at up to about 90 wt % with any of the lanthanides (Y, Er, Yb, Dy, Ho) as dopants at up to about 3 wt %; either Mg, Ca, or Mn or a combination thereof at no more than about 2 wt % and fluxing agent, such as a silicate glass at no more than about 6 wt %.

A green chip may be prepared from the dielectric layer-forming paste and the internal electrode layer-forming paste. In the case of a printing method, a green chip is prepared by alternately printing the pastes onto a substrate of polyethylene terephthalate (PET), for example, in laminar form, cutting the laminar stack to a predetermined shape and separating it from the substrate.

Also useful is a sheeting method wherein a green chip is prepared by forming green sheets from the dielectric layer-forming paste, printing the internal electrode layer-forming paste on the respective green sheets, and stacking the printed green sheets.

The binder is then removed from the green chip and fired. Binder removal may be carried out under conventional conditions, preferably under the following conditions where the internal electrode layers are formed of a base metal conductor such as nickel and nickel alloys.

The heating rate is preferably about 5 to 300° C./hour, more preferably 10 to 100° C./hour. The holding temperature is preferably about 200 to 400° C., more preferably 250 to 300° C. The holding time is preferably about ½ to 24 hours, more preferably 5 to 20 hours. The atmosphere is preferably air. The green chip is then fired in an atmosphere with an oxygen partial pressure of 10⁻⁸ to 10⁻¹² atm. Extremely low oxygen partial pressure should be avoided, since at such low pressures the conductor can be abnormally sintered and may become disconnected from the dielectric layers. At oxygen partial pressures above the range, the internal electrode layers are likely to be oxidized.

For firing, the chip preferably is held at a temperature of 1,100° C. to 1,400° C., more preferably 1,250 to 1,400° C. Lower holding temperatures below the range would provide insufficient densification whereas higher holding temperatures above the range can lead to poor DC bias performance. Remaining conditions for sintering preferably are as follows. Heating rate: 50 to 500° C./hour, more preferably 200 to 300° C./hour. The holding time is preferably about ½ to 8 hours, more preferably 1 to 3 hours. The cooling rate is preferably about 50 to 500° C./hour, more preferably 200 to 300° C./hour. The firing atmosphere preferably is a reducing atmosphere. An exemplary atmospheric gas is a humidified mixture of N₂ and H₂ gases.

Firing of the capacitor chip in a reducing atmosphere preferably is followed by annealing. Annealing is effective for re-oxidizing the dielectric layers, thereby optimizing the resistance of the ceramic to dielectric breakdown. The annealing atmosphere may have an oxygen partial pressure of at least 10⁻⁶ atm., preferably 10⁻⁵ to 10⁻⁴ atm. The dielectric layers are not sufficiently re-oxidized at low oxygen partial pressures below the range, whereas the internal electrode layers are likely to be oxidized at oxygen partial pressures above this range.

For annealing, the chip preferably is held at a temperature of lower than 1,100° C., more preferably 500° C. to 1,000° C. Lower holding temperatures below the range would oxidize the dielectric layers to a lesser extent, thereby leading to a shorter life. Higher holding temperatures above the range can cause the internal electrode layers to be oxidized (leading to a reduced capacitance) and to react with the dielectric material (leading to a shorter life). Annealing can be accomplished simply by heating and cooling. In this case, the holding temperature is equal to the highest temperature on heating and the holding time is zero.

Remaining conditions for annealing preferably are as follows. The holding time is preferably about 0 to 20 hours, more preferably 6 to 10 hours. The cooling rate is preferably about 50 to 500° C./hour, more preferably 100 to 300° C./hour.

The preferred atmospheric gas for annealing is humid nitrogen gas. The nitrogen gas or a gas mixture used in binder removal, firing, and annealing, may be humidified using a wetter. In this regard, water temperature preferably is about 5 to 75° C.

The binder removal, firing, and annealing may be carried out either continuously or separately. If done continuously, the process includes the steps of binder removal, changing only the atmosphere without cooling, raising the temperature to the firing temperature, holding the chip at that temperature for firing, lowering the temperature to the annealing temperature, changing the atmosphere at that temperature, and annealing.

If done separately, after binder removal and cooling down, the temperature of the chip is raised to the binder-removing temperature in dry or humid nitrogen gas. The atmosphere then is changed to a reducing one, and the temperature is further raised for firing. Thereafter, the temperature is lowered to the annealing temperature and the atmosphere is again changed to dry or humid nitrogen gas, and cooling is continued. Alternately, once cooled down, the temperature may be raised to the annealing temperature in a nitrogen gas atmosphere. The entire annealing step may be done in a humid nitrogen gas atmosphere.

The resulting chip may be polished at end faces by barrel tumbling and sand blasting, for example, before the external electrode-forming paste is printed or transferred and baked to form external electrodes. Firing of the external electrode-forming paste may be carried out under the following conditions: a humid mixture of nitrogen and hydrogen gases, about 600 to 800° C., and about 10 minutes to about 1 hour.

Pads are preferably formed on the external electrodes by plating or other methods known in the art.

The capacitor may be encased in resin, except for the pads, by any method known in the art.

The multilayer ceramic chip capacitors of the invention can be mounted on printed circuit boards, for example, by soldering.

The metal includes those typically employed for multilayer ceramic capacitors including nickel, silver, platinum, palladium, gold, tungsten, molybdenum, copper, rhodium, ruthenium or any combination thereof.

The method of applying the ceramic precursor and electrode material is not particularly limiting herein including ink jet, screen printing, xerography, patch coating, pad coating, flexography and gravure. Particularly preferred methods include transfer methods and direct methods. In transfer methods the ceramic or electrode precursors are applied to a substrate and then transferred to the tape. In direct methods the ceramic or electrode precursors are applied as an ink by a coating or printing technique such as gravure, ink jet, screen printing and the like. The electrode is preferably applied by either a screen printing technique or an ink jet technique. The dielectric material is preferably applied by a transfer technique. If dielectric is applied to the margins between the electrodes it is preferable that the dielectric be applied by a direct technique.

The present invention has been described with particular reference to the preferred embodiments without limit. It would be apparent to one of skill in the art, based on the description herein, that alternate embodiments could be envisioned without departing from the scope of the invention which is specifically set forth in the claims appended hereto.

Claimed is:

1. A process for forming a multilayer ceramic capacitor comprising:
depositing a ceramic precursor on a substrate;
depositing an electrode ink in a predetermined pattern on said ceramic precursor to form a green sheet wherein said electrode ink comprises an adhesion promoter;
overlaying said green sheet with at least one second green sheet to form a layered green sheet; and
fusing said layered green sheet under pressure.

2. The process for forming a multilayer ceramic capacitor of claim 1 further comprising:
depositing a second ceramic precursor in a second predetermined pattern on said ceramic precursor.

3. The process for forming a multilayer ceramic capacitor of claim 2 wherein said depositing a second ceramic precursor is prior to said depositing an electrode ink.

4. The process for forming a multilayer ceramic capacitor of claim 2 wherein said second ceramic precursor comprises a second adhesion promoter.

5. The process for forming a multilayer ceramic capacitor of claim 4 wherein said second adhesion promoter is selected from isoprenes; hydroabietyl alcohol; butadienes; acrylates; isocyanates; cyanoacrylates; urethanes; epoxies; natural wood derived tackifiers with a natural rubber base; waxes; styrene-butadiene rubber; styrenated block copolymers; hydrocarbon-modified rosen esters; aromatic and aliphatic hydrocarbon resins; phenolic modified rosin esters; modified rosins; rosin esters; and gum adhesives.

6. The process for forming a multilayer ceramic capacitor of claim 2 wherein said second ceramic precursor is deposited with a method selected from ink jet, screen printing, xerography, patch coating, pad coating, flexography and gravure.

7. The process for forming a multilayer ceramic capacitor of claim 6 wherein said second ceramic precursor is deposited by an ink jet method.

8. The process for forming a multilayer ceramic capacitor of claim 2 wherein said ceramic precursor and said second ceramic precursor are the same.

9. The process for forming a multilayer ceramic capacitor of claim 1 wherein said adhesion promoter is selected from isoprenes; hydroabietyl alcohol; butadienes; acrylates; isocyanates; cyanoacrylates; urethanes; epoxies; natural wood derived tackifiers with a natural rubber base; waxes; styrene-butadiene rubber; styrenated block copolymers; hydrocarbon-modified rosen esters; aromatic and aliphatic hydrocarbon resins; phenolic modified rosin esters; modified rosins; rosin esters; and gum adhesives.

10. The process for forming a multilayer ceramic capacitor of claim 1 wherein said pressure is no more than 5000 psi (352 Kg/cm).

11. The process for forming a multilayer ceramic capacitor of claim 10 wherein said pressure is no more than 2000 psi (141 Kg/cm).

12. The process for forming a multilayer ceramic capacitor of claim 1 wherein said electrode ink is deposited with a method selected from ink jet, screen printing and gravure.

13. The process for forming a multilayer ceramic capacitor of claim 12 wherein said electrode ink is deposited by an ink jet method.

14. The process for forming a multilayer ceramic capacitor of claim 1 wherein said electrode ink comprises nickel.

15. A capacitor formed by the method of claim 1.

16. A process for forming a multilayer ceramic capacitor comprising:
depositing a ceramic precursor on a substrate;
depositing an second ceramic in a predetermined pattern on said ceramic precursor wherein said second ceramic comprises an adhesion promoter;
depositing an electrode ink in a second predetermined pattern on said ceramic precursor to form a green sheet;
overlaying said green sheet with at least one second green sheet to form a layered green sheet; and
fusing said layered green sheet under pressure.

17. The process for forming a multilayer ceramic capacitor of claim 16 wherein said depositing an electrode ink is prior to said depositing said second ceramic precursor.

18. The process for forming a multilayer ceramic capacitor of claim 16 wherein said electrode ink comprises a second adhesion promoter.

19. The process for forming a multilayer ceramic capacitor of claim 18 wherein said second adhesion promoter is selected from isoprenes; hydroabietyl alcohol; butadienes; acrylates; isocyanates; cyanoacrylates; urethanes; epoxies; natural wood derived tackifiers with a natural rubber base; waxes; styrene-butadiene rubber; styrenated block copolymers; hydrocarbon-modified rosen esters; aromatic and aliphatic hydrocarbon resins; phenolic modified rosin esters; modified rosins; rosin esters; and gum adhesives.

20. The process for forming a multilayer ceramic capacitor of claim 16 wherein said electrode ink is deposited with a method selected ink jet, screen printing, xerography, patch coating, pad coating, flexography and gravure.

21. The process for forming a multilayer ceramic capacitor of claim 20 wherein said electrode ink is deposited by an ink jet method.

22. The process for forming a multilayer ceramic capacitor of claim 16 wherein said electrode ink comprises nickel.

23. The process for forming a multilayer ceramic capacitor of claim 16 wherein said adhesion promoter is selected from isoprenes; hydroabietyl alcohol; butadienes; acrylates; isocyanates; cyanoacrylates; urethanes; epoxies; natural wood derived tackifiers with a natural rubber base; waxes; styrene-butadiene rubber; styrenated block copolymers; hydrocarbon-modified rosen esters; aromatic and aliphatic hydrocarbon resins; phenolic modified rosin esters; modified rosins; rosin esters; and gum adhesives.

24. The process for forming a multilayer ceramic capacitor of claim 16 wherein said pressure is no more than 5000 psi (352 Kg/cm).

25. The process for forming a multilayer ceramic capacitor of claim 24 wherein said pressure is no more than 1000 psi (70 Kg/cm).

26. The process for forming a multilayer ceramic capacitor of claim 16 wherein said second ceramic precursor is deposited with a method selected from ink jet, screen printing and gravure.

27. The process for forming a multilayer ceramic capacitor of claim 26 wherein said second ceramic precursor is deposited by an ink jet method.

28. The process for forming a multilayer ceramic capacitor of claim 16 wherein said ceramic precursor and said second ceramic precursor are the same.

29. A capacitor formed with the method of claim 16.

30. A process for forming a multilayer ceramic capacitor comprising:
depositing a ceramic precursor on a substrate;
depositing an electrode ink in a predetermined pattern on said ceramic precursor wherein said electrode ink comprises an adhesion promoter;
depositing a second ceramic precursor in a second predetermined pattern on said ceramic precursor to form a green sheet wherein said second ceramic precursor comprises a second adhesion promoter;
overlaying said green sheet with at least one second green sheet to form a layered green sheet; and
fusing said layered green sheet under pressure wherein said pressure is no more than 2000 psi (140 Kg/cm).

31. The process for forming a multilayer ceramic capacitor of claim 30 wherein said depositing a second ceramic precursor is prior to said depositing an electrode ink.

32. The process for forming a multilayer ceramic capacitor of claim 30 wherein said adhesion promoter is selected from isoprenes; hydroabietyl alcohol; butadienes; acrylates; isocyanates; cyanoacrylates; urethanes; epoxies; natural wood derived tackifiers with a natural rubber base; waxes; styrene-butadiene rubber; styrenated block copolymers; hydrocarbon-modified rosen esters; aromatic and aliphatic hydrocarbon resins; phenolic modified rosin esters; modified rosins; rosin esters; and gum adhesives.

33. The process for forming a multilayer ceramic capacitor of claim 30 wherein said second adhesion promoter is selected from isoprenes; hydroabietyl alcohol; butadienes; acrylates; isocyanates; cyanoacrylates; urethanes; epoxies; natural wood derived tackifiers with a natural rubber base; waxes; styrene-butadiene rubber; styrenated block copolymers; hydrocarbon-modified rosen esters; aromatic and aliphatic hydrocarbon resins; phenolic modified rosin esters; modified rosins; rosin esters; and gum adhesives.

34. The process for forming a multilayer ceramic capacitor of claim 30 wherein said second ceramic precursor is deposited with a method selected from ink jet, screen printing and gravure.

35. The process for forming a multilayer ceramic capacitor of claim 30 wherein said second ceramic precursor is deposited by an ink jet method.

36. The process for forming a multilayer ceramic capacitor of claim 30 wherein said ceramic precursor and said second ceramic precursor are the same.

37. The process for forming a multilayer ceramic capacitor of claim 30 wherein said pressure is no more than 1000 psi (70 Kg/cm).

38. The process for forming a multilayer ceramic capacitor of claim 30 wherein said electrode ink is deposited with a method selected from ink jet, screen printing and gravure.

39. The process for forming a multilayer ceramic capacitor of claim 38 wherein said electrode ink is deposited by an ink jet method.

40. The process for forming a multilayer ceramic capacitor of claim 30 wherein said electrode ink comprises nickel.

41. A capacitor formed by the method of claim 30.
